(19) United States
(12) Patent Application Publication
(10) Pub. No.: US 2013/0129314 A1
(43) Pub. Date: May 23, 2013

(54) DIGITAL VIDEO RECORDER AND METHOD OF TRACKING OBJECT USING THE SAME

(71) Applicant: LG ELECTRONICS INC., Seoul (KR)

(72) Inventor: Hyoseung LIM, Seoul (KR)

(73) Assignee: LG ELECTRONICS INC., Seoul (KR)

(21) Appl. No.: 13/684,391

(22) Filed: Nov. 23, 2012

(30) Foreign Application Priority Data
Nov. 23, 2011 (KR) 10-2011-0122692

(51) Int. Cl. H04N 9/79

(52) U.S. Cl. CPC H04N 9/7904
USPC 386/239

(57) ABSTRACT

Provided are a digital video recorder and a method of tracking an object using the same. The method includes: receiving a video; encoding the video to generate an encoded video; extracting a motion vector from the encoded video; generating object movement information on an object on the basis of the motion vector; and tracking a temporal movement pattern of the object on the basis of the object movement information.

### CROSS-REFERENCE TO RELATED APPLICATIONS

The present application claims priority under 35 U.S.C. 119 and 35 U.S.C. 365 to Korean Patent Application No. 10-2011-0122692 (filed on Nov. 23, 2011), which is hereby incorporated by reference in its entirety.

### BACKGROUND

The present invention relates to a digital video recorder and a method of tracking an object using the same, and more particularly, to a digital video recorder for improving the search speed and efficiency of object tracking and a method of tracking an object using the same.

A digital video recorder is a device having a function for displaying or storing multichannel videos that a user can watch. A user may store a video received from external through a digital video recorder, or may watch the video through a video display device.

Moreover, recently suggested is a device or method for analyzing a video stored through a digital video recorder and searching for an object in a video according to a specific condition to extract only a necessary portion.

Such a general video analyzing method is to search for a video when each event occurs by additionally recording a specific event, for example, the time of when one of movement information, relay information, or POS information occurs or to search for a video of a specific time slot.

Additionally, a function for detecting movement occurrence in a specific area from a video having no event records is suggested as new method. However, since this function uses a method for decoding stored or recorded videos again and searching for motion occurrence in a corresponding area again, it takes a lot of time to search. Moreover, additional hardware is required for real-time search, and multichannel is not supported.

FIG. 1 is a view illustrating a process for tracking an object through a general video analysis.

Referring to FIG. 1, an object tracking device 10 using a general video analysis method includes a video receiving unit 11 for receiving a recorded video from external, an encoding unit 12 for encoding a video frame to convert them in a format for playback or storage, a motion detecting unit 13 for decoding a video frame, decoding a motion from the decoded frame, and extracting an object, and an object tracking unit 14 for tracking the extracted object to store its result or output it to a user.

As shown in FIG. 1, in order to track an object through a general method, a process for extracting an object from a video frame through the motion detecting unit 13 is required. For this, heavy data processing is required to recognize a moving object from a real-time video. Accordingly, resource usage for each channel is great, so that it is impossible to process multichannel video without additional hardware and resource.

### SUMMARY

Embodiments provide a digital video recorder for improving object search, tracking speed, and processing efficiency, and a method of tracking an object by using the same.

Embodiments also provide a digital video recorder for recognizing and tracking an object in a multichannel video by minimizing a resource usage for each channel, and a method of tracking an object by using the same.

In one embodiment, a method of tracking an object includes: receiving a video; encoding the video to generate an encoded video; extracting a motion vector from the encoded video; generating object movement information on an object on the basis of the motion vector; and tracking a temporal movement pattern of the object on the basis of the object movement information.

In another embodiment, an object tracking device includes: a video receiving unit for receiving a video; an encoder for encoding the video to generate an encoded video; a motion filtering unit for extracting a motion vector from the encoded video and generating object movement information on an object on the basis of the extracted motion vector; and an object tracking unit for tracking a temporal movement pattern of the object on the basis of the object movement information.

The details of one or more embodiments are set forth in the accompanying drawings and the description below. Other features will be apparent from the description and drawings, and from the claims.

### BRIEF DESCRIPTION OF THE DRAWINGS

FIG. 1 is a view illustrating a method of tracking an object through a general video playing/storing device.

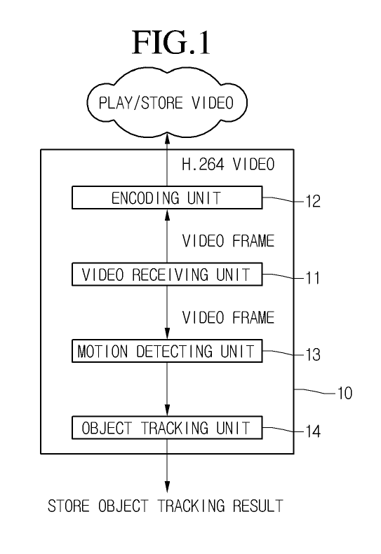

FIG. 2 is a block diagram illustrating a digital video recorder according to an embodiment of the present invention.

FIG. 3 is a block diagram illustrating a digital video recorder according to another embodiment of the present invention.

FIG. 4 is a flowchart illustrating a method of tracking an object according to an embodiment of the present invention.

FIG. 5 is a flowchart illustrating a method of tracking an object in a video according to an embodiment of the present invention.

### DETAILED DESCRIPTION OF THE EMBODIMENTS

The contents below illustrate only the principles of the present invention. Therefore, although this specification does not clearly describe or illustrate the present invention, those skilled in the art may realize the principles of the present invention and may invent various devices within the concept and range of the present invention. Additionally, as a rule, all conditional terms and embodiments listed in this specification are intended for purposes to understand the concept of the present invention and should be understood as not being limited to specifically enumerated embodiments and states.

Additionally, in addition to the principles, perspectives, and embodiments of the present invention, all detail descriptions enumerating specific embodiments should be understood as intended to include structural and functional equivalents thereof. Additionally, such equivalents should be understood as including currently known equivalents and all equivalents that will be developed in the future, that is, all devices invented to perform the same function regardless of a structure.

Accordingly, for example, a block diagram of the specification should be understood as representing a conceptual perspective of an exemplary circuit that embodies the principles of the present invention. Similarly, all flowcharts, state transition diagrams, and pseudo-codes may be substantially written on a computer readable medium and, regardless of whether a computer or a processor is clearly illustrated, should be understood as representing various processes performed by a computer or a processor.

Functions of various devices illustrated in the drawing including processors or functional blocks displayed with a similar concept thereof may be provided as hardware having a capability for executing software in relation to appropriate software. When provided by processors, the functions may be provided by a single dedicated processor, a single sharing processor, and each of a plurality of processors and some of them may be shared.

Furthermore, the clear usage of processors, controls, and the terms suggested with a similar concept should not be construed by exclusively quoting hardware having a capability for executing software, and should be understood as implicitly including digital signal processor (DSP) hardware and also ROM, RAM, and nonvolatile memory for storing software without limitations. Other well-known hardware may be included.

In relation to the claims herein, components expressed as means to perform functions in the detailed description are intended to include a combination of circuit devices for performing the functions or all methods for performing the functions including all types of software with firmware/micro code, and are combined with appropriate circuits for executing the software in order to perform the functions. Since the present invention defined by such the claims is combined with functions provided by variously enumerated means and means that the claims require, any means that provides the functions should be understood as equivalents identified from the specification.

The above-mentioned purposes, features, and advantages become clearer through the following detailed description relating to the accompanying drawings, and accordingly, those skilled in the art may easily realize the technical ideal of the present invention. Additionally, if it is determined that detailed description for well-known techniques relating to the present invention unnecessarily obscures the main idea of the present invention, the detailed description will be omitted.

Hereinafter, preferred embodiments of the present invention will be described in detail with reference to the accompanying drawings.

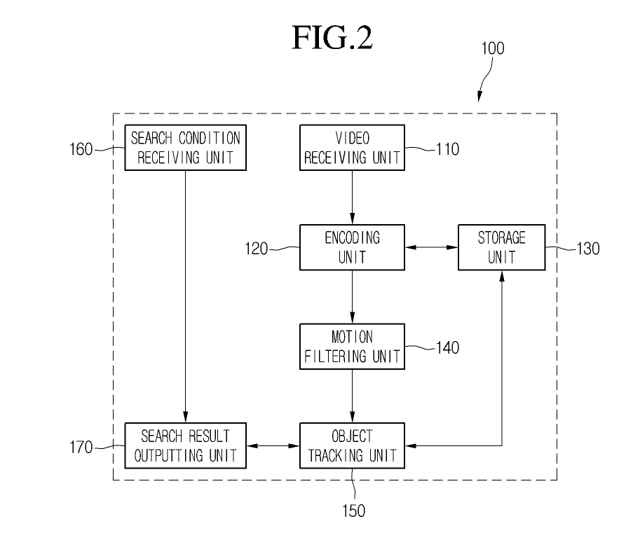

FIG. 2 is a block diagram illustrating a digital video recorder according to an embodiment of the present invention.

As shown in FIG. 2, the digital video recorder 100 includes an video receiving unit 110 for receiving a video from external, an encoding unit 120 for encoding the received video for storage or playback, a storage unit 130 for storing the encoded video, a motion filtering unit 140 for extracting an object on the basis of a motion vector generated during encoding, and an object tracking unit 150 for tracing the extracted object in the video.

Also, the digital video recorder 100 may further include a search condition receiving unit 160 for receiving an object search condition and a search result outputting unit 170 for searching for an object and outputting a result according to the object search condition.

The video receiving unit 110 receives a video from external. The received video is transmitted to the encoding unit 120 and then encoded. The received video may be a video received from a tuner or an external input device. Moreover, the received video may be a monitoring video captured by a surveillance camera device, and may be a specific video inputted by a user.

Furthermore, the encoding unit 120 encodes the received video for storage or playback in order to generate an encoded video. Here, encoding, as a digital video compression technique for increasing storage or playback efficiency, means to reduce a video storage and transmission resource by converting a high bit rate of a large video that a typical raw digital video sequence has into a low bit rate. Decoding means to reconfigure the encoded video into an original video version.

Moreover, the encoding unit 120 may use motion estimation and motion compensation in order for such encoding. This is used for an inter picture compression technique among intra picture compression and inter picture compression techniques of a video compression technique, and the motion estimation is a process for estimating a motion between video frames. An encoder using motion estimation matches blocks of current samples in a current frame to candidate blocks having the same size in a search area of another frame, i.e. a reference frame. When a similar area is matched in a search area of a reference frame, the encoding unit 120 parameterizes a position change between current and candidate blocks as a motion vector.

Here, the motion vector may be a two dimensional value having a parallel component representing the left or right spatial displacement or a vertical component representing the upward or downward spatial displacement. Also, the motion compensation may be a process for reconfigurating frames from reference frames by using the motion vector.

The encoding unit 120 may search for matching of a similar area block by using such a motion vector in order to perform motion estimation. Also, once the motion estimation is made, the number of bits may be saved in lossy compression, and this may improve the quality of a video or reduce an overall bit rate.

Moreover, the encoding unit 120 may include at least one processing device (not shown) and a memory (not shown) in order for such encoding. As a basic component, a processing device may execute a computer-executable command and may be an actual or virtual processor. In a multi processing system, a plurality of processing devices may execute a computer-executable command in order to improve processing ability. Memory may be one of volatile memories such as register, cache, or RAM, or one of nonvolatile memories such as ROM, EEPROM, and flash memory, or a predetermined combination of two types. Software implementing encoding by using at least one of the techniques for motion estimation and motion vector extraction may be stored in memory.

The storage unit 130 may store a video encoded by the encoding unit 120, or may provide the stored video to a video playback device (not shown) to be played. Additionally, the storage unit 130 may be mobile or immobile, and may include a magnetic disk, a magnetic tape or cassette, CD-ROM, DVD, or an arbitrary another medium used for storing information and accessible in a computer environment.

The motion filtering unit 140 extracts a plurality of motion vectors from each of a plurality of frames of an encoded video. The motion filtering unit 140 extracts a plurality of filtered motion vectors by filtering the plurality of extracted motion vectors. At this point, the motion filtering unit 140 may remove noise of the plurality of extracted motion vectors. The motion filtering unit 140 may extract a plurality of filtered motion vectors that meets a filtering condition by filtering the plurality of extracted motion vectors according to the filtering condition. For example, the plurality of filtered motion vectors meeting a filtering condition may be a motion vector group having a component within a predetermined range. Especially, a group of the motion vectors having a component within a predetermined range may be a group of motion vectors having the same component. After that, the motion filtering unit 140 extracts movement information on a moving object from each of a plurality of frames of an encode video on the basis of the plurality of filtered motion vectors. By doing so, the motion filtering unit 140 generates one or more pieces of object movement information for each of a plurality of frames. One or more pieces of object movement information with respect to one frame may be generated. One piece of object movement information corresponds to one object.

Such movement information may include at least one of information on the shape of an object, information on an object position, information on a representative movement vector of an object, and information on the color of an object. The representative movement vector of an object may represented with the movement direction and motion size of an object or the vertical movement size and parallel movement size of an object. Additionally, the movement information may further include at least one of histogram information on an object and information on the covariance of an object.

Also, the object tracking unit 150 analyzes a plurality of movement information for a plurality of frames and tracks a temporal movement pattern of a moving object. The object tracking unit 150 adds the temporal movement pattern of an object on the movement information generated by the motion filtering unit 150 in order to generate object feature information. By doing so, the object tracking unit 150 generates a plurality of object feature information corresponding to a plurality of moving objects, respectively. Then, the object tracking unit 150 may store a plurality of object feature information in the storage unit 130 as database, and may provide feature information according a user's request later.

Moreover, when a user searches for a specific object from a stored video, the search condition receiving unit 160 may receive a search condition for that. The search condition receiving unit 160 may include all devices that provide an input in a computing environment. The search condition may include at least one of the form, position, temporal movement pattern, and color information (for example, histogram or HOG) of an object for which a user wants to search.

Then, the search result outputting unit 170 compares the received search condition from the search condition input unit 160 with a plurality of feature information for a plurality of objects (which are tracked by the object tracking unit 160 and then stored) in order to determine whether there is a matching object.

Then, if there is a matching object, the search result outputting unit 170 may output a video of a portion that the matching object moves as a search result, and if there is no matching object, may output a search failure message.

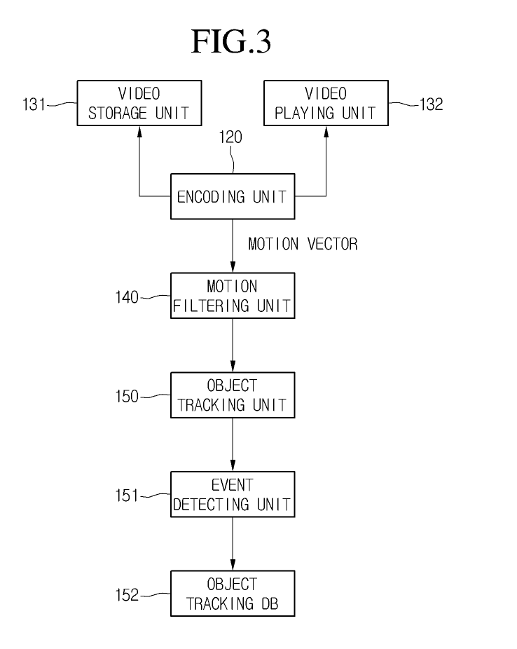

FIG. 3 is a block diagram illustrating a digital video recorder according to another embodiment of the present invention.

Referring to FIG. 3, the digital vide recorder may further include a video storage unit 131 for separately storing an encoded video, a video playing unit 132 for playing the encoded video, an event detecting unit 151 for detecting a specific event on the movement information on a tracked object, and an object tracking database (DB) 152 for storing the detected event information and specific information on an object in a database, in addition to the above mentioned encoding unit 120, motion filtering unit 140, and object tracking unit 150.

The video storage unit 131 and the video playing unit 132 may store or play the video, for example, H.264 format video data, which are compressed and transmitted by the encoding unit 120.

Also, since the motion filtering unit 120 of FIG. 3 performs the same or similar operation as that of FIG. 2, and generates object movement information for each of a plurality of frames, its detailed description will be omitted.

Since the object tracking unit 150 of FIG. 3 performs the same or similar operation as that of FIG. 2, and generates object feature information for a plurality of frames, its detailed description will be omitted.

Also, the event detecting unit 151 compares and determines feature information on an object tracked by the object tracking unit 150 and predetermined event information, in order to determine whether a specific event is detected.

Also, after determining a specific event, the event detecting unit 151 may store an object tracking result and corresponding time data for the specific event in the object tracking DB 152. This may be applicable when an object search function using a digital video recorder is used. Also, the object tracking DB 152 may store the video of a corresponding time or may store a network address for a corresponding video stored in another storage device, in addition to an object tracking result on the video.

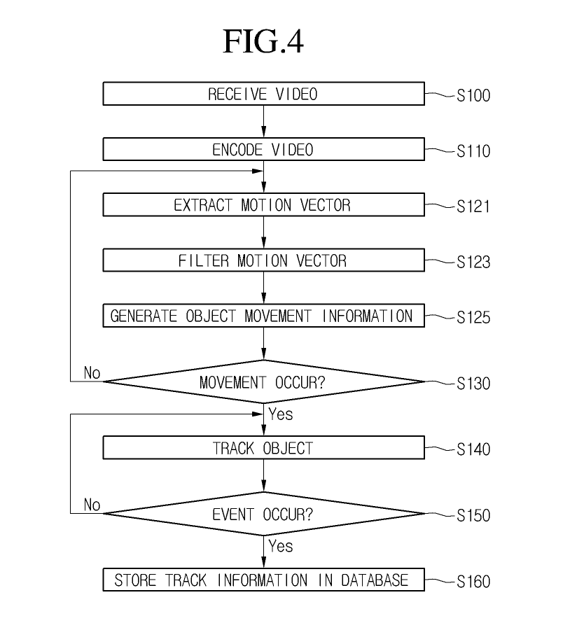

FIG. 4 is a flowchart illustrating a method of tracking an object according to an embodiment of the present invention.

Referring to FIG. 4, first, the video input unit 110 receives a video from external or a video stored in the storage unit 130 in operation S100.

Also, the encoding unit 120 encodes the received video and generates the encoded video in operation S110.

Then, the motion filtering unit 140 extracts a plurality of motion vectors from each of a plurality of frames of the encoded video in operation S121. At this point, the motion filtering unit 140 may continuously collect a motion vector during an encoding process and may extract a motion vector from the encoding completed video.

The motion filtering unit 140 filters a plurality of motion vectors with respect to a plurality of frames in order to generate a plurality of the filtered motion vectors with respect to the plurality of frames in operation S123.

The motion filtering unit 140 generates a plurality of pieces of object movement information with respect to the plurality of frames on the basis of the plurality of the filtered motion vectors with respect to the plurality of frames in operation S125. At this point, one or more pieces of object movement information with respect to one frame may be generated. One piece of object movement information corresponds to one object. As described above, each of a plurality of pieces of object movement information may include at least one of information on the shape of an object, information on an object position, information on a representative motion vector of an object, information on the color of an object, histogram information on an object, and information on an object covariance.

Also, the object tracking unit 150 determines whether there is a moving object in a video according to the movement information extracted by the motion filtering unit 140 in operation S130. If there is no moving object, the motion filtering unit 140 receives motion vector information on the extracted next picture in order to determine whether movement occurs.

Moreover, when it is determined that there is an moving object, the object tracking unit 150 generates a plurality of object feature information corresponding to a plurality of objects on the basis of a plurality of pieces of object movement information for a plurality of frames in operation S140. As described above, each object feature information may include at least one of information on a temporal movement pattern of an object, information on the shape of an object, information on an object position, information on the color of an object, histogram information on an object, and information on an object covariance.

Also, the event detecting unit 151 determines whether a temporal movement pattern of an object corresponding to a predetermined specific event during an object tracking operation in operation S150. When a specific event does not occur, object tracking may be continuously performed.

Moreover, when the event detecting unit 151 determines that an event occurs as a temporal movement pattern of an object corresponding to a specific event occurs, it stores object feature information in the object tracking DB 152 in correspondence to a specific event. The stored result information may be applicable during an object search operation according to a search condition later.

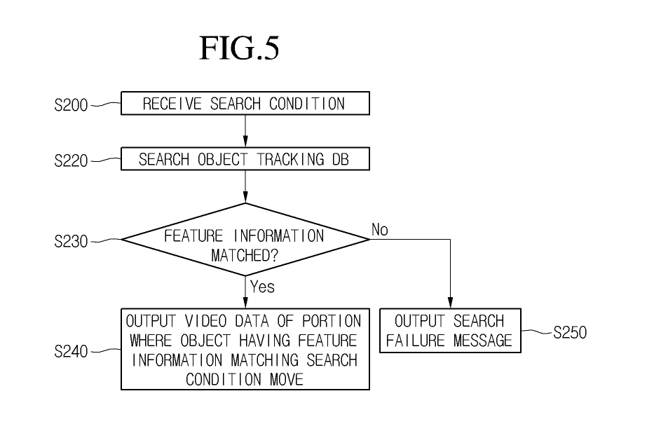

FIG. 5 is a view illustrating an operation for searching for an object by receiving a search condition in an object tracking method according to an embodiment of the present invention.

Referring to FIG. 5, the search condition input unit 160 may receive a search condition in operation S200. The search condition may be inputted from a user, and an input means may be one of touch input devices such as a keyboard, a mouse, a pen, or a trackball, a voice input device, a scanning device, or other devices for providing an input in a computing environment.

The search condition may include at least one of the form, position, temporal movement pattern, and color information (for example, histogram or HOG) of an object for which a user wants to search.

The search result outputting unit 170 searches for a plurality of object feature information stored in the object tracking DB 152 or the storage unit 130 in operation S220, and determines whether there is an object having feature information that matches or is partially similar to the search condition in operation S230.

Later, if there is an object having feature information matching the search condition, the search result outputting unit 170 outputs video data of a portion where a corresponding object moves in operation S240. If there is no object having feature information matching the search condition, the search result outputting unit 170 outputs a search failure message in operation S250.

Resource consumption may be minimized by tracking an object with a motion vector generated during an encoding process of a digital video recorder. Also, since this is used for tracking and analyzing an object of a video and its result is stored in a database, an object is searched according to various conditions. Therefore, fast search may be provided.

Additionally, since a function for extracting motion information by an object unit and performing search without additional hardware by using an encoder of a digital video recorder for multichannel processing is provided, object tracking for multichannel becomes possible.

According to an embodiment of the present invention, a motion vector is extracted from a video encoder of a digital video recorder, and an object is tracked by using the motion vector.

Especially, without additional hardware such as a general motion detecting device, resource usage is minimized, so that object recognition and search speed may be improved.

Additionally, resource usage for each channel is minimized, so that multichannel object tracking is possible in a digital video recorder for supporting a multichannel of more than 16 channels. Also, this may be stored in a database and provided to a user.

The method of tracking an object by using a digital video recorder according to the present invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, and optical data storage devices, and further includes carrier waves (such as data transmission through the Internet).

The computer readable recording medium can also be distributed over network coupled computer systems so that the computer readable code is stored and executed in a distributed fashion. (Also, functional programs, codes, and code segments for accomplishing the present invention can be easily construed by programmers skilled in the art to which the present invention pertains.)

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of tracking an object, the method comprising:
receiving a video;
encoding the video to generate an encoded video;
extracting a motion vector from the encoded video;
generating object movement information on an object on the basis of the motion vector; and
tracking a temporal movement pattern of the object on the basis of the object movement information.

2. The method of claim 1, wherein the object movement information comprises information on a representative movement vector on the object.

3. The method of claim 2, further comprising:
receiving a temporal movement pattern as a search condition; and
when the search condition matches the temporal movement pattern of the object, outputting a portion where a movement of the object occurs in the video.

4. The method of claim 2, wherein the object movement information comprises information on the shape of the object, information on the position of the object, and information on the color of the object.

5. The method of claim 1, wherein the generating of the object movement information comprises:
removing noise from the extracted motion vector; and
generating the object movement information on the basis of the noise-removed motion vector having.

6. The method of claim 1, further comprising storing a temporal movement pattern of the tracked object in a database.

7. The method of claim 1, wherein the video comprises a video captured by a camera.

8. The method of claim 1, wherein
the extracting of the motion vector comprises extracting a plurality of motion vectors from each of a plurality of frames in the encoded video; and
the generating of the object movement information comprises generating the object movement information on the basis of the plurality of extracted motion vectors.

9. The method of claim 8, wherein
the generating of the object movement information on the basis of the plurality of extracted motion vectors comprises generating one or more pieces of object movement information for each of a plurality of frames on the basis of the plurality of extracted motion vectors; and
the tracking of the temporal movement pattern comprises tracking a plurality of temporal movement patterns respectively corresponding to a plurality of objects on the basis of a plurality of pieces of object movement information for the plurality of frames.

10. The method of claim 8, wherein the tracking of the temporal movement pattern comprises:
filtering the plurality of extracted motion vectors according to a filtering condition to extract a plurality of filtered motion vectors matching the filtering condition; and
generating the object movement information on the basis of the plurality of filtered motion vectors.

11. The method of claim 10, wherein extracting the plurality of filtered motion vectors matching the filtering condition comprises:
extracting a group of motion vectors having a component within a predetermined range.

12. An object tracking device comprising:
a video receiving unit for receiving a video;
an encoder for encoding the video to generate an encoded video;
a motion filtering unit for extracting a motion vector from the encoded video and generating object movement information on an object on the basis of the extracted motion vector; and
an object tracking unit for tracking a temporal movement pattern of the object on the basis of the movement information.

13. The device of claim 12, wherein the object movement information comprises information on a representative movement vector on the object.

14. The device of claim 13, further comprising:
a search condition receiving unit for receiving a temporal movement pattern as a search condition; and
a search result outputting unit for outputting a portion that a movement of the object occurs in the video when the search condition matches the temporal movement pattern of the object.

15. The device of claim 13, wherein the object movement information further comprises at least one of information on the shape of the object, information on the position of the object, and information on the color of the object.

16. The device of claim 12, wherein the motion filtering unit removes noise from the extracted motion vector and generates the object movement information on the basis of the noise-removed motion vector.

17. The device of claim 12, wherein the motion filtering unit extracts a plurality of motion vectors from each of a plurality of frames in the encoded video and generates the object movement information on the basis of the plurality of extracted motion vectors.

18. The device of claim 17, wherein
the motion filtering unit generates at least one object movement information for each of a plurality of frames on the basis of the plurality of extracted motion vectors; and
the object tracking unit tracks a plurality of temporal movement patterns respectively corresponding to a plurality of objects on the basis of a plurality of pieces of object movement information for the plurality of frames.

19. The device of claim 17, wherein the motion filtering unit filters the plurality of extracted motion vectors according to a filtering condition to extract a plurality of filtered motion vectors matching the filtering condition, and generates the object movement information on the basis of the plurality of filtered motion vectors.

20. The device of claim 19, wherein the motion filtering unit extracts a group of motion vectors having a component within a predetermined range.
